(19) United States
(12) Patent Application Publication
(10) Pub. No.: US 2017/0035004 A1
(43) Pub. Date: Feb. 9, 2017

(54) Hanging Basket with Trellis Support System

(71) Applicant: Larry McMurray, Hugo, MN (US)

(72) Inventor: Larry McMurray, Hugo, MN (US)

(21) Appl. No.: 15/230,074

(22) Filed: Aug. 5, 2016

Related U.S. Application Data
(60) Provisional application No. 62/202,569, filed on Aug. 7, 2015.

(51) Int. Cl. A01G 17/06; A01G 9/02; A01G 9/12; A01G 7/04; A01G 5/04

(52) U.S. Cl. CPC A01G 17/06; A01G 7/045; A01G 5/04; A01G 9/12; A01G 9/02

(57) ABSTRACT

This invention relates to a hanging basket with a trellis support system that includes one or more flexible mesh strips and one or more flexibly stiff rods, the rod or rods interwoven throughout the mesh strip or strips to allow climbing plants and vines to grow along the trellis support system, thereby creating attractive plant creations.

This application claims the filing date of and relates to the provisional application by the same inventor, Ser. No. 62/202,569 filed on Aug. 7, 2015.

### SUMMARY OF INVENTION

This invention relates to a hanging basket with a trellis support system that includes flexible mesh and a flexibly stiff rod interwoven throughout the mesh, to allow climbing plants and vines to grow along the trellis support system, thereby creating attractive plant creations.

### DETAILED DESCRIPTION OF DRAWINGS

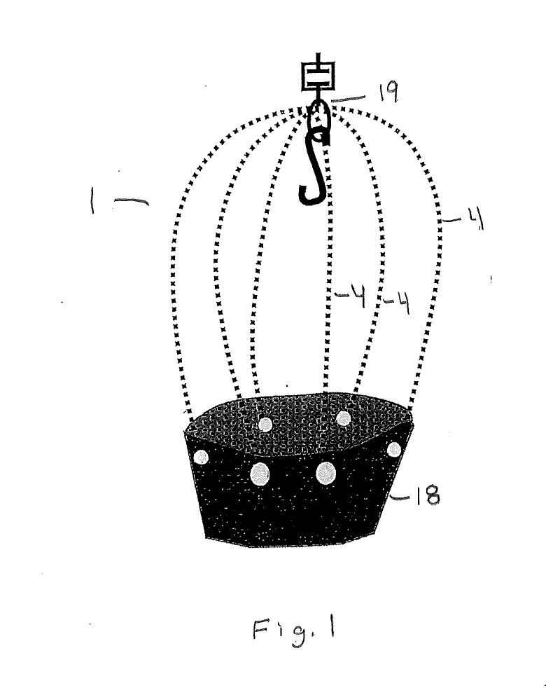

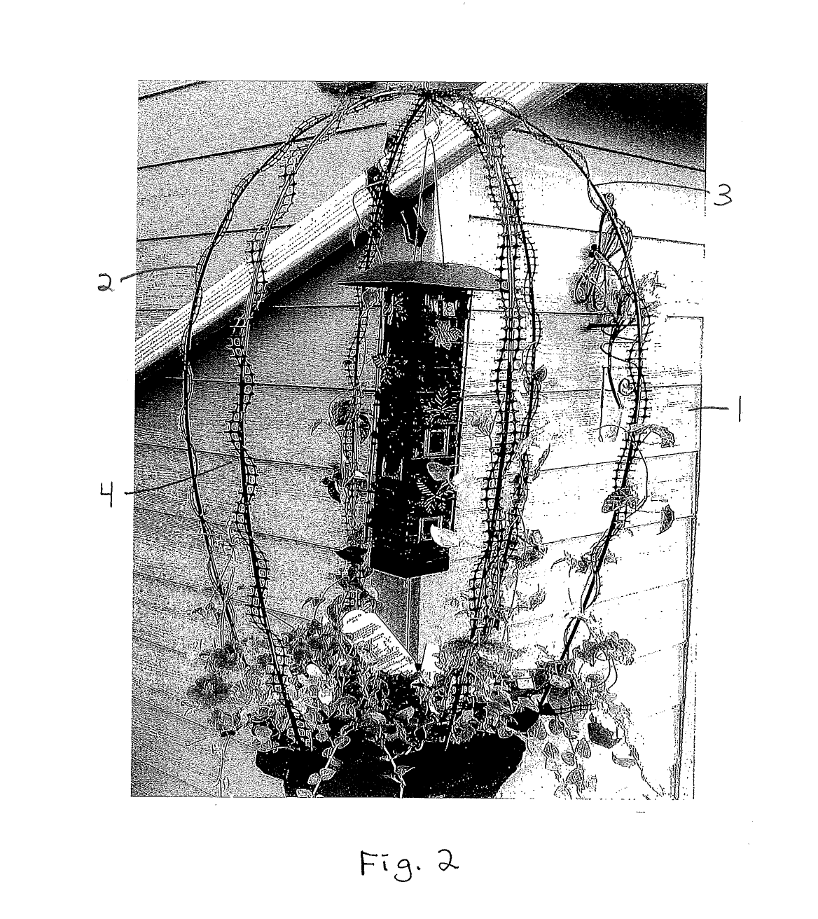

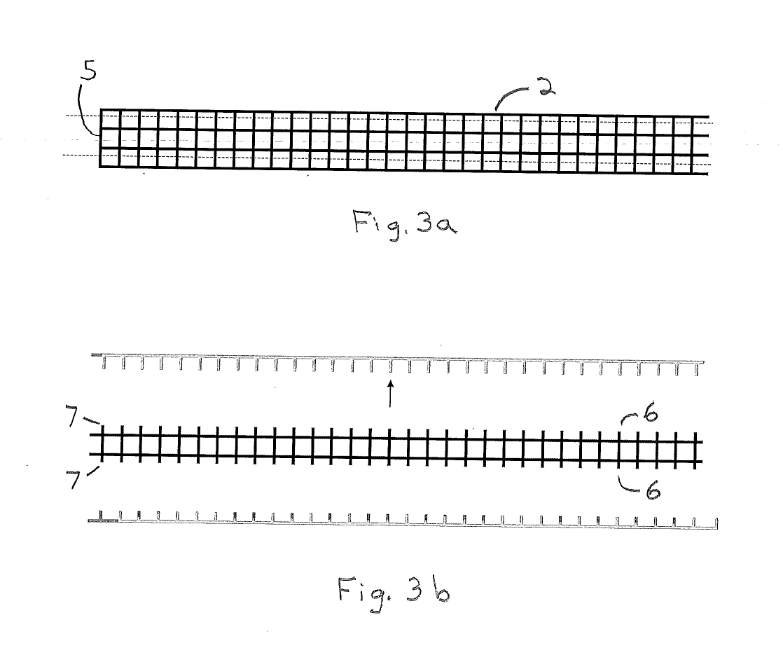

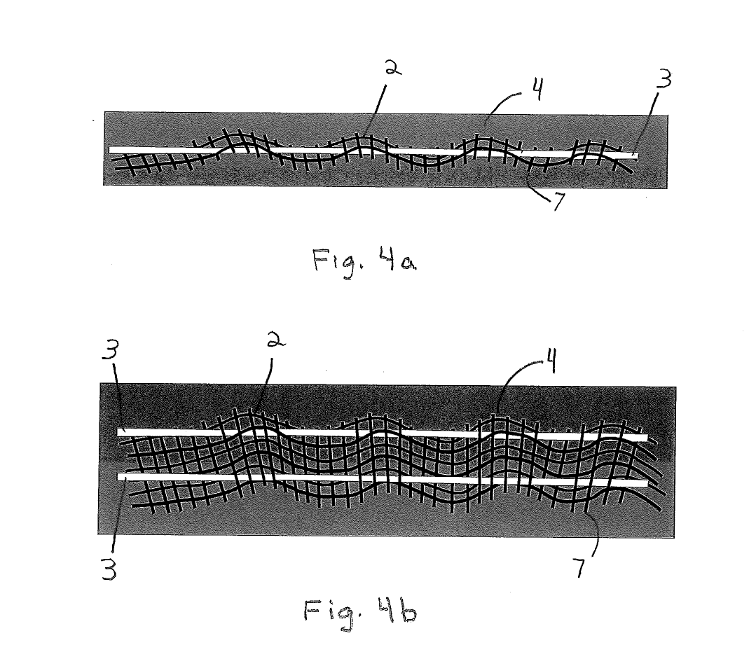

As shown in FIG. 1, a hanging basket with trellis support system 1 is disclosed. Referring now to FIG. 2, the hanging basket 1 comprises a flexible mesh support strip 2 and a flexibly stiff rod member 3 interwoven through the flexible mesh support strip 2, thereby forming a flexible mesh support strip assembly 4. The flexible mesh support strip 2 further comprises a grid-like construction with at least one row of four-sided shaped elements 5 in which the flexibly stiff rod member can be interwoven, and two longitudinal edges 6, the longitudinal edges comprising stub edges 7, as shown in FIGS. 3a and 3b, forming the assembly 4, as shown in FIGS. 4a and 4b.

FIGS. 4a and 4b show the mesh 2 component of the flexible mesh support strip assembly 4 with the stubs 7 on the longitudinal edges 6 and the flexibly stiff rod member 3, and further shows the flexibly stiff rod member 3 threaded or woven into the row of four-sided shaped elements 5 in the mesh support strip 2.

The preferred embodiment comprises one or more flexible mesh strip support assemblies, each with a flexibly stiff rod member interwoven throughout the length of the mesh, each end of the mesh assembly anchored to a flower pot, with a hanging means for attaching the hanging basket with trellis support means to form a trellis or other structure.

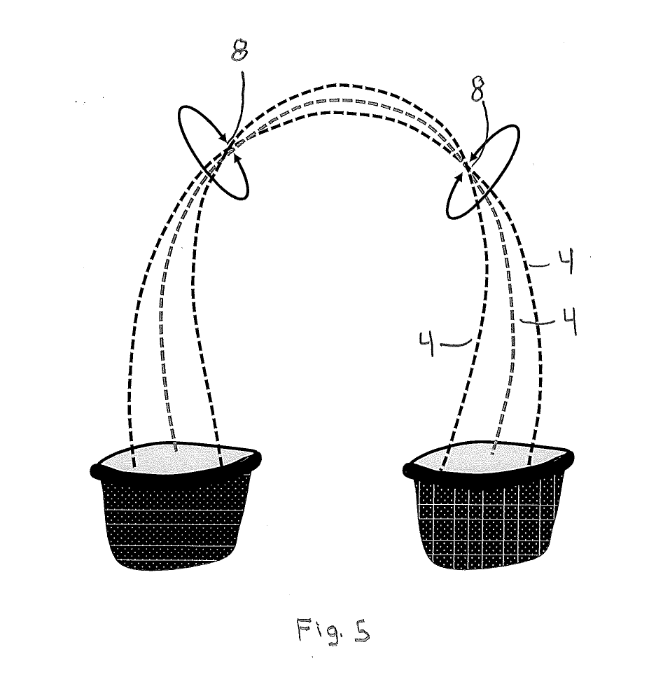

FIG. 5 shows another embodiment where three or more flexible mesh support strip assemblies 4 are used, each end of the mesh assemblies are anchored to separate pots, with each of the ends are spread apart from each other and anchored or pushed into the ground or soil in separate pots. The members can be tethered together at one of more tangent points 8 for structural stability, as shown in FIG. 5.

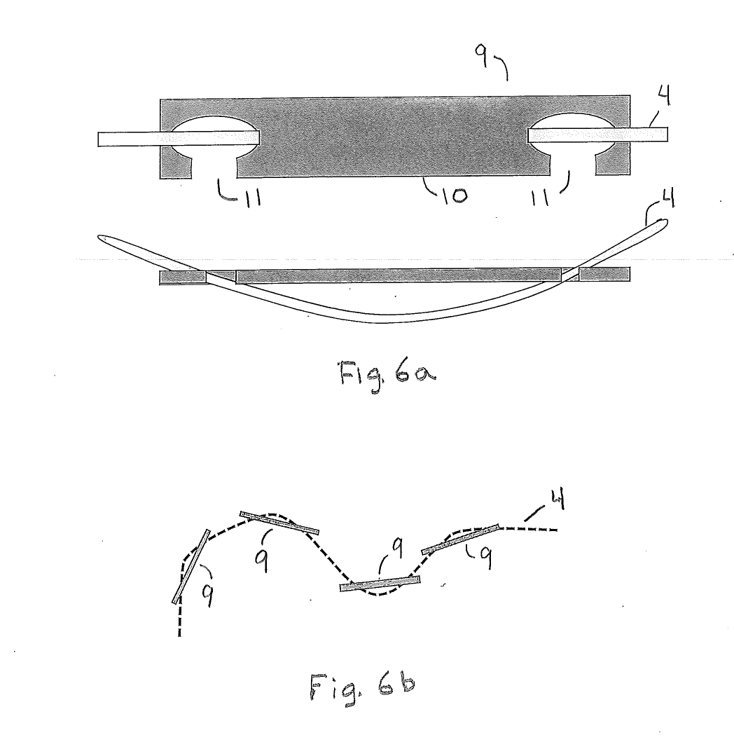

Referring now to FIGS. 6a and 6b, another embodiment is shown comprising a support strip angle slat 9 comprising a straight rigid member 10 with two or more key holes 11 to retain the flexible mesh support member assembly 4 in a static position once flexed into the key holes for the purpose of securing an angle direction. Multiple slats can be used on one flexible mesh support member assembly 4 to form compound linear curves providing a load bearing support, as shown in FIG. 6b.

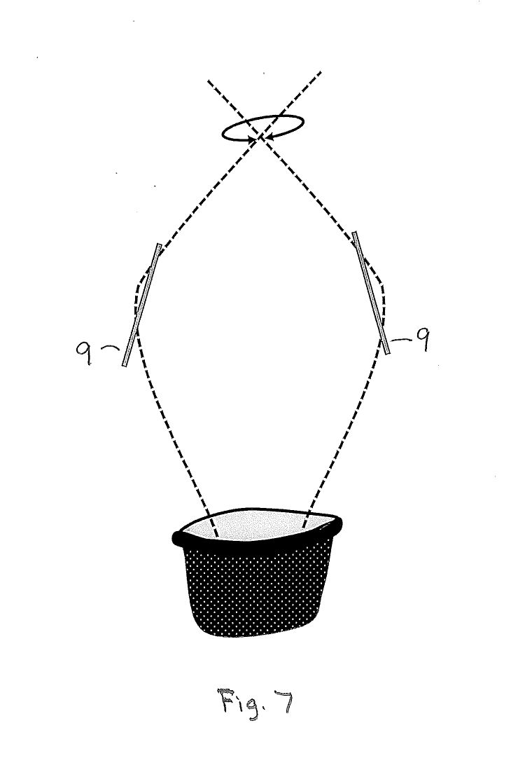

FIG. 7 shows an example of the flexible support strip angle slats 9 in use, illustrating a free standing support structure in a garden pot and the trellis feature to support vining plants. Means to support and decorate with electrical lighting and seasonal decorations can also be added.

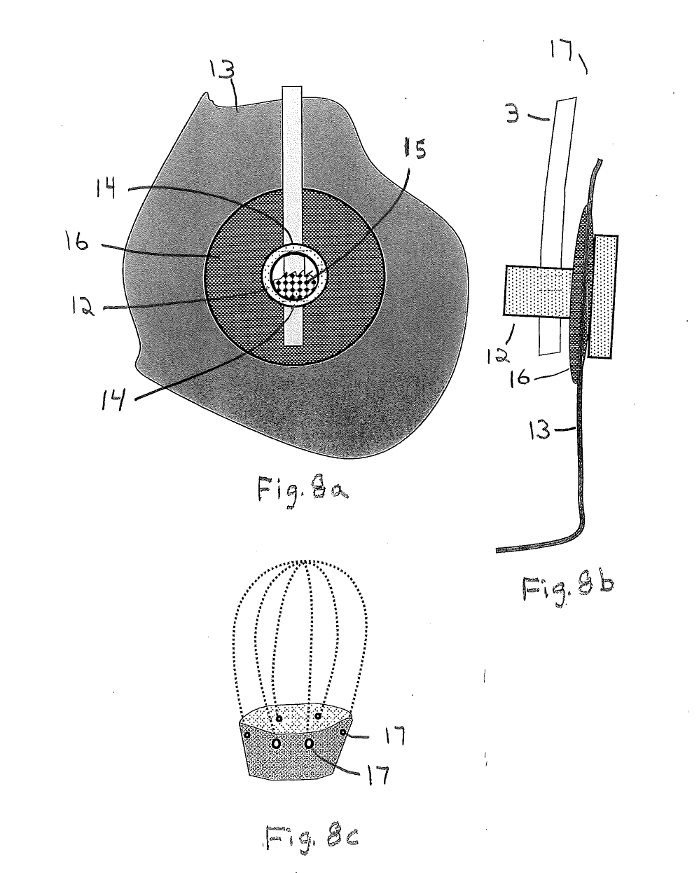

FIGS. 8a, 8b, and 8c show various means to anchor the flexible mesh support strip assemblies on cloth, vinyl or any other material. FIG. 8b discloses the use of a shoulder bushing 12 through the material 13 and then the flexibly stiff rod 3 of the flexible mesh support assembly 4 is inserted through a predrilled hole 14 and secured from sliding back out with a bonding agent 15 or mechanical means. Use of a grommet 16 is also illustrated. The anchor means 17 is shown in FIG. 8b, and on the plant pot in FIG. 8c.

Referring back to FIG. 1, the hanging basket with trellis support system 1 is disclosed showing yet another embodiment of three flexible mesh support strip assemblies 4 bent in a U shape and secured on a fabric planter base 18 and joined at the top tangent point with a loose fitting hanging bracket 19.

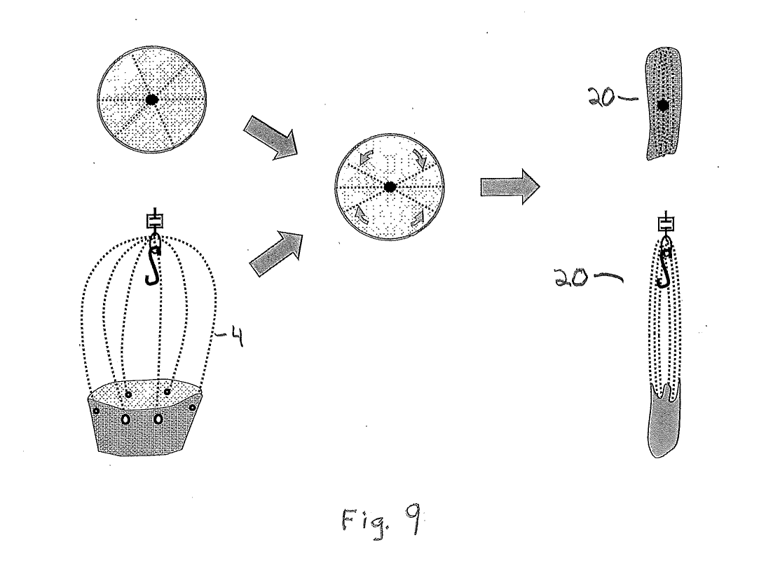

FIG. 9 shows another embodiment where the flexible mesh support strip assemblies 4 function as a collapsible planter 20 for minimizing storage when not in use.

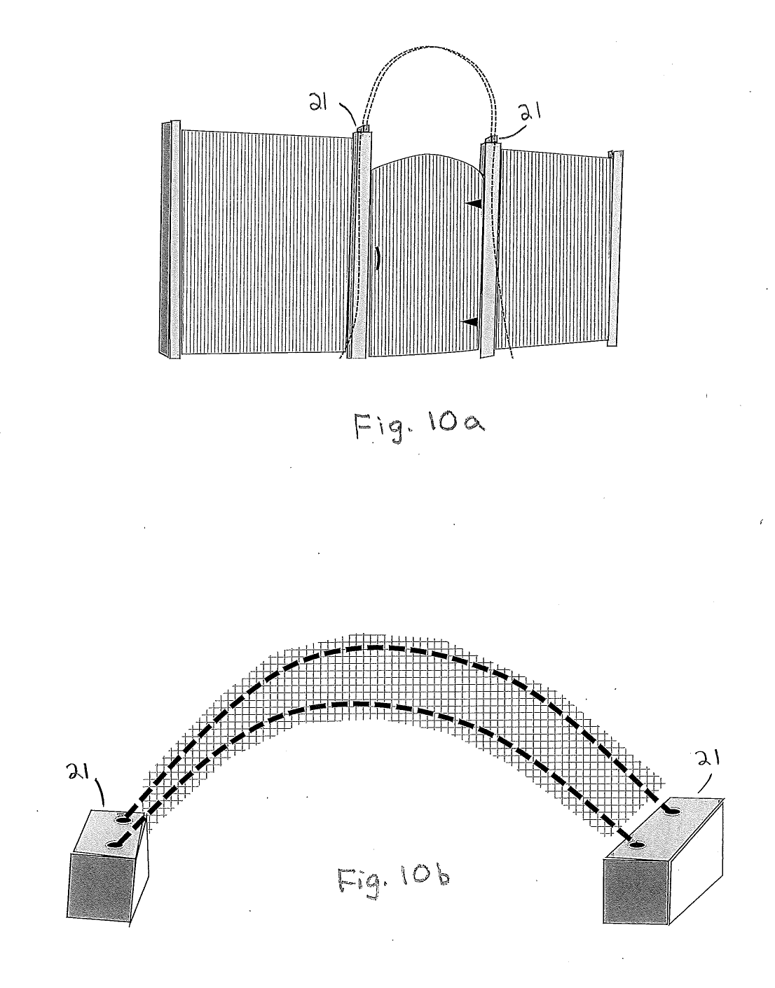

In another embodiment, the mesh comprises a wider width with two or more additional rows of mesh squares along its length and further comprises more than one rod woven in the mesh, and one new design feature to incorporate mounting blocks 21 to support the rods of the trellis assembly to a structure, illustrating an arbor type trellis over a gate, as shown in FIGS. 10a and 10b.

Yet another embodiment comprises the means to have a photocell on the hanging basket that would supply an untethered power source for electric devices supported below the swivel on the basket.

Yet another embodiment would comprise decorative electric lights, a sound device such as bird sounds or music, and means to rotate the trellis with wireless remote means.

I claim:

1. A trellis support system comprising a flexible mesh support strip and a flexibly stiff rod member interwoven through the flexible mesh support strip, thereby forming a flexible mesh support strip assembly, the flexibly stiff rod member comprising two ends.

2. The trellis support system of claim 1 wherein the flexible mesh support strip comprises a grid-like construction with at least one row of four-sided shaped elements in which the flexibly stiff rod member can be interwoven, two ends, a length, and two longitudinal edges, the longitudinal edges comprising stub edges.

3. The trellis support system of claim 1 comprising a plurality of flexible mesh strips and a plurality of flexibly stiff rod members wherein each flexibly stiff rod member is interwoven throughout each mesh strip and each end of the mesh assembly is anchored to a structure.

4. The trellis support system of claim 3 wherein the structure is a flower pot basket, and the trellis support system further comprises a hanging means for attaching the basket with trellis support means to a trellis or other structure.

5. The trellis support system of claim 4 comprising three or more flexible mesh support strip assemblies, each end of the mesh assemblies are anchored in separate flower pot baskets, wherein each of the ends are spread apart from each other and anchored to separate flower pot baskets or pushed into soil in the separate flower pot baskets.

6. The trellis support system of claim 3 wherein the mesh assemblies are tethered together at one of more tangent points for structural stability.

7. The trellis support system of claim 3 further comprising at least one support strip angle slat, the support strip angle slat comprising a straight rigid member with two or more key holes through which the mesh assembly is interwoven to retain the flexible mesh support member assembly in a static position once interwoven into the key holes for the purpose of securing an angle direction to the mesh assembly.

8. The trellis support system of claim 7 comprising multiple slats, wherein one flexible mesh support member assembly is interwoven through the key holes of the slats to form compound linear curves providing a load bearing support.

9. The trellis support system of claim 3 further comprising electrical lighting means and electrical lighting support means.

10. The trellis support system of claim 3 further comprising seasonal decoration means and seasonal decoration support means.

11. The trellis support system of claim 3 wherein the plurality of flexible mesh support strip assemblies are bent into a U shape and secured on a fabric planter base and joined at the top tangent point with a loose fitting hanging bracket.

12. The trellis support system of claim 11 wherein the flexible mesh support strip assemblies function as a collapsible planter for minimizing storage when not in use.

13. The trellis support system of claim 3 wherein the flexible mesh support strip comprises two or more rows of mesh squares along its length and further comprises more than one rod interwoven in the mesh.

14. The trellis support system of claim 13 further comprising at least two mounting blocks, wherein the end of each mesh and rod are attached to a separate mounting block, thereby supporting the trellis assembly to a structure.

15. The trellis support system of claim 4 further comprising a powered energy means, a rotating motor means, a wired or wireless circuit means connecting the powered energy means and the motor whereby the basket can be made to rotate.

16. The trellis support system of claim 15 further comprising a sound device such as bird sounds or music wirelessly or electronically connected to the powered energy means and circuit means.

17. The trellis support system of claim 16 wherein the powered energy means is a solar powered energy means, the solar powered energy means further comprising a remote control means for wirelessly controlling the rotating motor means and the bird sounds or music.
